(19) United States
(12) Patent Application Publication
(10) Pub. No.: US 2018/0191267 A1
(43) Pub. Date: Jul. 5, 2018

(54) APPARATUSES, METHODS, AND SYSTEMS FOR CIRCUITRY USING SYNCHRONOUS RECTIFIERS

(71) Applicant: Intel Corporation, Santa Clara, CA (US)

(72) Inventors: Kamyar Keikhosravy, Vancouver (CA); Shahriar Mirabbasi, Vancouver (CA); David Harkness, Vancouver (CA); Hamid Abdollahi, Vancouver (CA)

(21) Appl. No.: 15/397,599

(22) Filed: Jan. 3, 2017

(51) Int. Cl. H02M 7/219

(52) U.S. Cl. CPC H02M 7/219; H02M 2007/2195

(57) ABSTRACT

Embodiments include apparatuses, methods, and systems for an alternating current (AC) to direct current (DC) converter including a synchronous rectifier to convert an AC input signal to a DC output signal. The AC to DC converter may further include a feedback circuit coupled to an output terminal of the synchronous rectifier to sample the DC output signal and to generate a digital signal to represent a voltage of the DC output signal and a controller coupled to receive the digital signal from the feedback circuit. The controller may compare the digital signal to a threshold, and based on the comparison, control an adjustment of the voltage of the DC output signal. Additional embodiments may also be described.

### FIELD

Embodiments of the present disclosure relate generally to the technical field of electronic circuits, and more particularly to synchronous rectifiers.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Synchronous rectifiers provide higher conversion efficiency than diode-based rectifiers. In many applications, such as wireless energy harvesting applications, the main task of the rectifier is to convert the induced alternating current (AC) incident signal to a stable direct current (DC) voltage. In many cases, dependent on a number of stages and input voltage level, the synchronous rectifiers implemented in complementary metal-oxide-semiconductor (CMOS) technology suffer from increased leakage current and/or poor conduction paths which result in the reduction of sensitivity and power conversion efficiency.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 is a block diagram of an example alternating current (AC) to direct current (DC) converter including a circuit for improving synchronous rectifier efficiency in accordance with various embodiments.

FIG. 2 is a diagram of an example synchronous rectifier circuit that may be included in the AC to DC converter of FIG. 1 in accordance with various embodiments.

FIG. 3 is a circuit diagram of a voltage adjustment circuit that may be included in the synchronous rectifier circuit of FIG. 2 in accordance with various embodiments.

FIG. 4 is an example flow diagram of a method associated with FIGS. 1-3 in accordance with various embodiments.

FIG. 5 illustrates an example system configured to employ the apparatuses and methods described herein, in accordance with various embodiments.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

In systems such as, e.g., wireless energy harvesting (WEH) systems, a voltage of an alternating current (AC) input signal below an optimal point or particular level may lead to a drop in rectifier power conversion efficiency (PCE) and hence a voltage of a direct current (DC) output signal. For example, the voltage of the AC input signal extracted from a receiver may be inversely proportional to the distance between the receiver and transmitter. For longer than ideal or particular distances, the voltage of the AC input signal may drop, resulting in a significant drop in rectifier PCE, thus limiting the range of operation of the WEH system. Accordingly, in embodiments, a digital controller may assist in dynamically adjusting gate operating voltages of transistors in a synchronous rectifier to alleviate a drop in the rectifier PCE when the voltage of the AC input signal decreases. In various embodiments described below, the performance of rectifiers, e.g., metal-oxide-semiconductor-field-effect-transistor (MOSFET)-based rectifiers, may be improved by more efficiently driving gates of the MOSFETs of the rectifiers.

In embodiments, an AC to DC converter including a rectifier, such as a synchronous rectifier, to convert an AC input signal to a DC output signal is described. In embodiments, the AC to DC converter may include a feedback circuit coupled to an output terminal of the rectifier to sample the DC output signal and to generate a digital signal to represent a voltage of the DC output signal. For some embodiments, a digital processor or controller may be coupled to receive the digital signal from the feedback circuit. In various embodiments, the controller may analyze a performance of the rectifier and adjust a DC voltage of the transistors of the rectifier to achieve improved performance and sensitivity. In embodiments, the controller may compare the digital signal to a threshold, and based on the comparison, control an adjustment of the voltage of the DC output signal. Accordingly, in embodiments, a performance of metal-oxide-semiconductor-field-effect-transistor (MOSFET)-based rectifiers may be improved by properly driving the gates of the transistors.

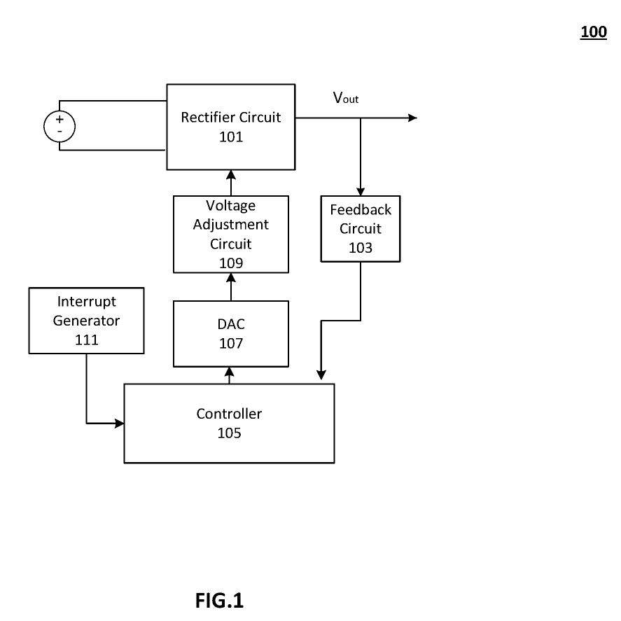

FIG. 1 is a block diagram of an example alternating current (AC) to direct current (DC) converter 100 for improving synchronous rectifier efficiency in accordance with various embodiments. In the illustrated embodiment, AC to DC converter 100 may include a rectifier circuit block 101, feedback circuit block 103, digital controller or controller block 105, digital-to-analog converter (DAC) block 107, voltage adjustment circuit block 109, and interrupt generator block 111. In embodiments, rectifier circuit block 101 may convert an alternating current (AC) input signal to a direct current (DC) output signal. In embodiments, rectifier circuit block 101 may include a metal-oxide-semiconductor-field-effect-transistor (MOSFET)-based full wave rectifier circuit. In embodiments, feedback circuit block 103 may include an analog-to-digital converter (ADC) and may be coupled to an output terminal of a rectifier circuit of rectifier circuit block 101 to sense or sample the DC output signal. In embodiments, feedback circuit block 103 may generate a digital value to represent a voltage of the DC output signal (Vₒᵤₜ) and provide the digital value to controller block 105.

In embodiments, controller block 105 may be coupled to receive the digital value from feedback circuit block 103 and to compare the voltage of the DC output signal (represented by the digital value) with a predetermined threshold voltage or threshold voltage (Vₘᵢₙ) to determine an adjustment of gate operating voltages of rectifier circuit block 101, thereby adjusting the voltage of the DC output signal. The gate operating voltages may refer to DC bias voltages that are received at the gate terminals of the transistors in the rectifier circuit block 101, e.g., in addition to the AC signals based on the AC input signal. Accordingly, in embodiments, controller block 105 may determine the adjustment of the gate operating voltages and provide a signal such as a binary or digital signal to DAC block 107. In embodiments, controller block 105 may instruct DAC block 107 to generate a DC voltage to adjust the gate operating voltage for one or more MOSFET switches in rectifier circuit block 101. In embodiments, the threshold voltage Vₘᵢₙ may be a voltage associated with a designated tolerance value. The designated tolerance value may represent an amount of change in the voltage of the DC output signal where an adjustment of the DC bias voltages may benefit PCE, according to various embodiments.

Next, in the embodiment, voltage adjustment circuit block 109 may be coupled to receive the DC voltage from DAC block 107. In embodiments, voltage adjustment circuit block 109 may apply the DC voltage to a gate terminal of the one or more MOSFET switches of rectifier circuit block 101. The voltage adjustment circuit block 109 may add the DC voltage to a respective AC voltage signal that is passed to the gate terminals of the one or more MOSFET switches based on the AC input signal, according to various embodiments. In various embodiments, an interrupt generator block 111 may be coupled to send controller 105 an electrical interrupt signal. In embodiments, the interrupt generator block 111 may be optional and may generate the electrical interrupt signal due to a change in voltage requirements for a system including AC to DC converter 100. For example, voltage requirements may change when a device or system including the AC to DC converter 100 moves or changes position. In embodiments, such a device or system may be associated with a motion sensor, e.g., an accelerometer, gyroscope, or other sensor to detect movement or device position. In embodiments, the interrupt generator block 111 may generate the electrical interrupt signal in response to a movement or change in device position to trigger controller block 105 to request that feedback circuit block 103 sense or sample the DC output signal under new conditions to compare the voltage of the DC output signal with the threshold voltage Vₘᵢₙ.

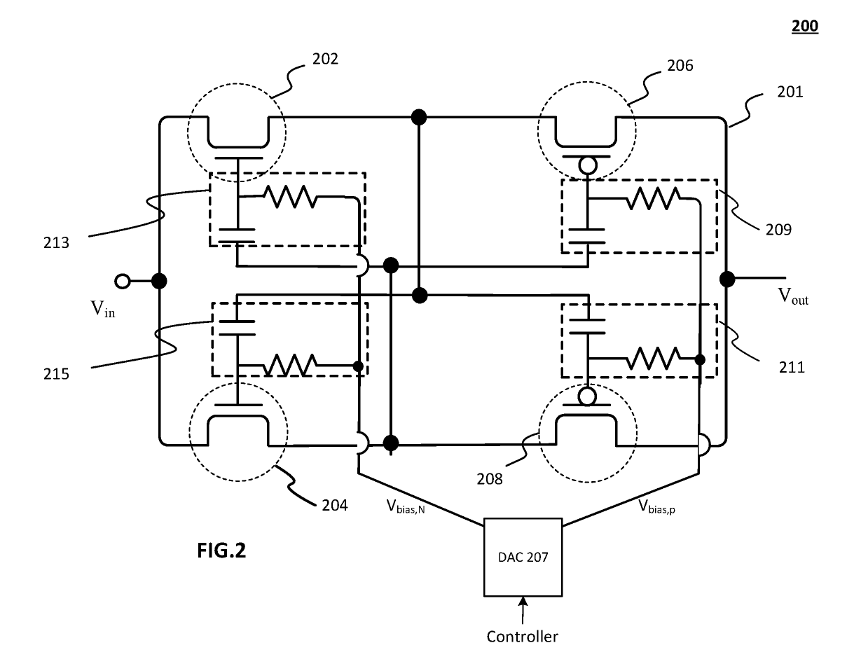

FIG. 2 is circuit diagram 200 of an example rectifier circuit 201 in accordance with various embodiments. In the embodiment, rectifier circuit 201 may correspond to rectifier circuit block 101 of FIG. 1. As shown in the embodiment, voltage adjustment circuits 209, 211, 213, and 215 are indicated in the dashed rectangles and may correspond to voltage adjustment circuit block 109 while DAC 207 may correspond to DAC block 107 of FIG. 1. In the illustrated embodiment, rectifier circuit 201 may include a pair of N-channel metal-oxide-semiconductor (NMOS)-field-effect transistors, such as, for example, N-channel transistors 202 and 204 and a pair of P-channel metal-oxide-semiconductor (PMOS)-field-effect transistors, such as, for example, P-channel transistors 206 and 208. In embodiments, voltage adjustment circuits 213 and 215 may be coupled to a gate of respective N-channel transistors 202 and 204 while voltage adjustment circuits 209 and 211 may be coupled to a respective gate of P-channel transistors 206 and 208.

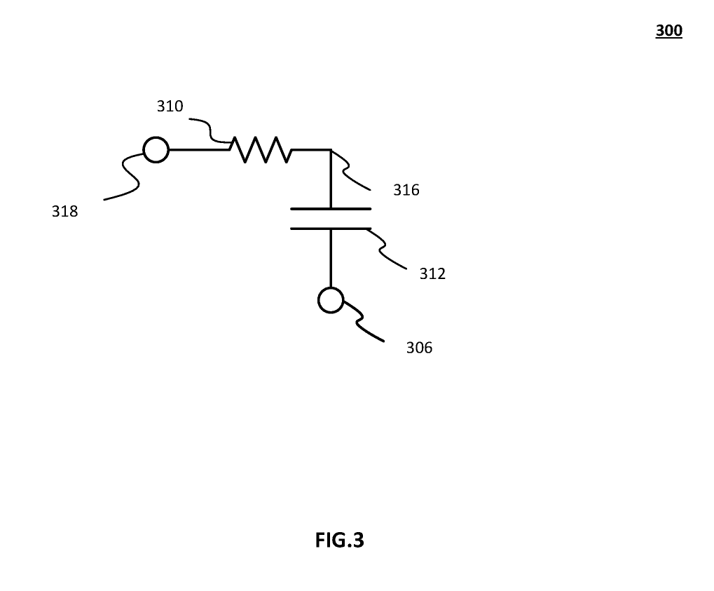

FIG. 3 is an isolated view of an example embodiment of voltage adjustment circuit 300 to further illustrate voltage adjustments circuits 209, 211, 213 and 215 of FIG. 2. In embodiments, voltage adjustment circuit 300 may include a resistor 310 that may be coupled to receive a DC voltage at node 318 from DAC block 107 while capacitor 312 may be coupled on a first side at a node 316 to add the AC voltage to a gate terminal of an NMOS-field-effect transistor or PMOS-field-effect transistor. In embodiments, capacitor 312 may be coupled on a second side to an internal node 306.

Voltage adjustment circuit 300 is an example embodiment of a circuit for adjusting (e.g., adding or subtracting to) a DC voltage level added to the AC voltage. In various embodiments, voltage adjustment circuit 300 may be implemented by other suitable configurations that may apply a signal with AC and DC components to the gate terminals of MOSFET switches of a rectifier circuit such as rectifier circuit 201. In some embodiments, the resistors of FIG. 2 and FIG. 3 may include an external or integrated resistor or integrated transistor configured as resistance. Note furthermore, that in accordance with various embodiments, rectifier circuit 201 may be one stage of a potentially multi-stage synchronous rectifier that is implemented in differential architecture included in the AC to DC converter of FIG. 2.

Accordingly, returning to FIG. 2, gate terminals of N-channel transistors 202 and 204 and P-channel transistors 206 and 208 may be coupled to respective voltage adjustment circuits 213, 215 and 209 and 211. In embodiments, a capacitor (e.g., capacitor 312 of FIG. 3) may be included in one or more of respective voltage adjustment circuits 213, 215, 209, and 211 to provide AC signals of rectifier circuit 201 to the gate terminals of the transistors through capacitive coupling. In embodiments, a resistor (e.g., resistor 310) may be large enough to set a DC component of the gate voltage. Accordingly, a DC bias voltage (e.g., V_{bias, N} or V_{bias,p}), may be added to the AC input signal of a respective N-channel transistor or P-channel transistor to adjust the gate operating voltages. In embodiments, a digital controller may control an adjustment of gate operating voltages of N-channel transistors 202 and 204 or of P-channel transistors 206 and 208 by adjusting a DC voltage level to be applied to the gate terminals of the respective N-channel transistors or P-channel transistors 206 and 208.

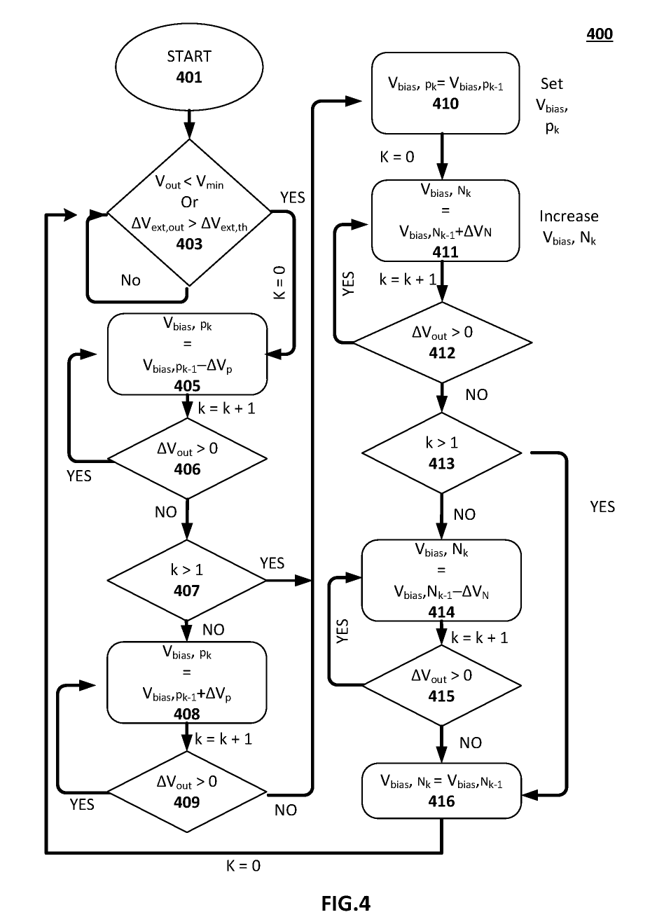

Next, FIG. 4 is an example flow diagram 400 associated with a digital controller such as included in digital controller block 105 of FIG. 1. In an embodiment, the digital controller may increase or decrease a DC voltage level to adjust a DC bias voltage (e.g. V_{bias, pk} or V_{bias, N}_{ₖ}) of respective P-channel transistors and N-channel transistors of a rectifier circuit to optimize or improve performance of the rectifier circuit. In the embodiment, after a start block 401, where at a first iteration, k=0, the digital controller may determine if a voltage of DC output signal Vₒᵤₜ is less than a reference or threshold voltage Vₘᵢₙ at a decision block 403. In embodiments, threshold voltage Vₘᵢₙ may be a predetermined voltage associated with an improved or optimized voltage of the DC output signal produced by rectifier circuit 201. In embodiments, decision block 403 may also test a separate condition, whether a change in the voltage of DC output signal Vₒᵤₜ due to external sources (e.g., ΔV_{ext, out}) is greater than an allowed tolerance amount (e.g., ΔV_{ext, th}). In embodiments, the allowed tolerance amount ΔV_{ext, th} may be defined as an amount of allowable change in the voltage of DC output signal Vₒᵤₜ due to external sources, such as changes in drained current at an output of the rectifier circuit, changes in geometry of a device including the rectifier circuit or changes in an amplitude level of the AC input signal. In embodiments, if the answer is YES to either condition at decision block 403, then the digital controller may determine that an adjustment of the gate operating voltages is needed. Accordingly, for the embodiment, at a block 405, a gate bias voltage of a P-channel transistor (e.g., V_{bias, pk}) may be adjusted by decreasing (decrementing) a voltage amount ΔVₚ from a previous gate bias voltage V_{bias, pk-1}, e.g., V_{bias, pk}=V_{bias, pk-1}−ΔVₚ. In embodiments, voltage amount ΔVₚ may be a predetermined or dynamically calculated stepped voltage amount based on parameters of the rectifier.

Accordingly, after V_{bias, pk} is adjusted at block 405, the iteration counter may be increased to k=k+1. In embodiments, at a next block 406, voltage of the DC output signal Vₒᵤₜ is checked and if there is a decrease, then the answer at decision block 406, ΔVₒᵤₜ>0, is NO. In embodiments, the path moves to decision block 407, where if the current iteration is a first iteration of decreasing the gate bias voltage V_{bias, pk}, then the answer to k>1 is NO. Accordingly, at a next block 408, the digital controller may increase (e.g., increment) gate bias voltage V_{bias, pk} with voltage amount ΔVₚ. Accordingly, gate bias voltage V_{bias,pk} may increase to V_{bias,pk}=V_{bias, pk-1}+ΔVₚ. In embodiments, by increasing the gate bias voltage, the digital controller may discourage (e.g., decrease) current flow such as leakage current through the transistor. In embodiments, discouraging a leakage current through the transistor may increase the voltage of the DC output signal Vₒᵤₜ.

Next, in embodiments, after increasing the gate bias voltage V_{bias, pk}, the voltage of the DC output signal Vₒᵤₜ is checked at block 409. Accordingly, in embodiments, if the voltage of the DC output signal Vₒᵤₜ increases, the process returns to a block 408. The gate bias voltage V_{bias,pk} may continue to be increased by looping through blocks 408 and 409 until Vₒᵤₜ starts decreasing. In embodiments, a decrease in the voltage of the DC output signal Vₒᵤₜ may indicate an overboosting of rectifier circuit 201. Accordingly, in embodiments, when a decrease in the voltage of the DC output signal Vₒᵤₜ is observed, e.g., ΔVₒᵤₜ>0 is no longer satisfied, the answer at block 409 is NO and the process flows to block 410. Accordingly, at a next block 410, the gate bias voltage of the P-channel transistor V_{bias, pk} may be set to the previous gate bias voltage, such that V_{bias,pk}=V_{bias,pk-1}.

Returning to block 406, if in the alternative, there was a performance improvement, e.g., an increase in the voltage of the DC output signal Vₒᵤₜ, after decreasing gate bias voltage V_{bias,pk} in block 405, then the answer at decision block 406 is YES. In embodiments, the digital controller returns to block 405 to continue to decrease the gate bias voltage V_{bias, pk} with voltage amount ΔVₚ. In embodiments, the loop may continue until a decrease in the voltage of the DC output signal Vₒᵤₜ is observed. Accordingly, in embodiments, if the answer to ΔVₒᵤₜ>0 at block 406 is NO, the process may move out of the loop to join block 407 where if k>1, the process moves to a next block 410, where the gate bias voltage of the P-channel transistor V_{bias, pk} may be set to the previous gate bias voltage, such that V_{bias,pk}=V_{bias, pk-1}.

Accordingly, in embodiments, whether the process arrives at block 410 from block 407 or 409, a similar process may now be repeated for the N-channel transistors. Thus, in embodiments, beginning at a next block 411, a gate bias voltage of an N-channel transistor V_{bias,N}_{ₖ} may be increased (e.g., incremented) by a voltage amount ΔV_{N} such that V_{bias,N}=V_{bias,N}_{_{k−1}}+ΔV_{N}. In embodiments, voltage amount ΔV_{N} may be a predetermined or dynamically calculated stepped voltage amount based on parameters of the rectifier circuit. At a next block 412, for the embodiment, the digital controller may determine if the voltage of DC output signal Vₒᵤₜ is rising in response to the increase. Accordingly, if the answer to ΔVₒᵤₜ>0 is YES, then the process may return to block 411 to increase V_{bias,N}_{ₖ} again. In embodiments, the loop may continue until a drop in the voltage of the DC output signal Vₒᵤₜ is observed. Accordingly, in embodiments, if the answer to ΔVₒᵤₜ>0 at block 412 is NO, the process may move out of the loop to block 413. In embodiments, if k>1, then the process may move to block 414 where the gate bias voltage of the N-channel transistor may be set to a previous gate voltage, V_{bias,N}_{ₖ}=V_{bias, N}_{_{k−1}}. In the alternative, if the answer to k>1 at block 413 is NO, the process flows to block 414, where the gate bias voltage V_{bias,pk} may be decreased (e.g., decremented) with a voltage amount ΔV_{N}. Accordingly, gate bias voltage V_{bias, Nk} may decrease to V_{bias,Nk}=V_{bias,N}_{_{k−1−}}ΔV_{N}. In embodiments, by decreasing the gate bias voltage V_{vias,Nk}, the digital controller is discouraging (e.g., decreasing) current flow through the transistor. In embodiments, discouraging a leakage current through the transistor may assist in increasing the voltage of the DC output signal Vₒᵤₜ and the efficiency of rectifier circuit 201.

In embodiments, if decreasing the gate bias voltage V_{bias,Nk} is succeeding in increasing the voltage of the DC output signal Vₒᵤₜ, e.g., ΔVₒᵤₜ>0 at block 415, the process returns to a block 414. In embodiments, the gate bias voltage V_{bias,Nk} may continue to be decreased by looping through blocks 414 and 415 until Vₒᵤₜ decreases. In embodiments, a decrease in the voltage of the DC output signal Vₒᵤₜ may indicate an overboosting of rectifier circuit 201. Accordingly, in embodiments, when a decrease in the voltage of the DC output signal Vₒᵤₜ is observed, e.g., ΔVₒᵤₜ>0 is no longer satisfied, the answer at block 415 is NO and the process flows to block 416 where the gate bias voltage of the N-channel transistor V_{bias, Nk} may be set to the previous gate bias voltage, such that V_{bias,N}_{ₖ}=V_{bias,N}_{_{k−1}}. Finally, in embodiments, a monitoring of the voltage of DC output signal Vₒᵤₜ may continue at a block 403, where if Vₒᵤₜ<Vₘᵢₙ or ΔV_{ext,out}>ΔV_{ext, th}, the adjustment of gate bias voltages V_{bias, pk} and V_{bias,N}_{ₖ} may begin again.

Accordingly, in embodiments, the controller may compare the digital signal to a voltage threshold, and based on the comparison, control a DC bias voltage of a transistor of the synchronous rectifier to control an adjustment of the voltage of the DC output signal. In embodiments, if the digital signal indicates the voltage of the DC output signal is below the voltage threshold or a change in voltage due to external forces exceeds a tolerance, the controller may control the DC bias voltage to increase the voltage of the DC output signal by facilitating a current flow through the transistor. If in embodiments, e.g., according to blocks 407-409 and 413-415, the iteration is a first iteration of an increase or decrease of the gate bias voltage and an updated digital signal indicates a resulting decrease, rather than increase, in the voltage of the DC output signal, the controller may control the bias voltage to discourage the current flow through the transistor to attempt to increase the voltage of the DC output signal.

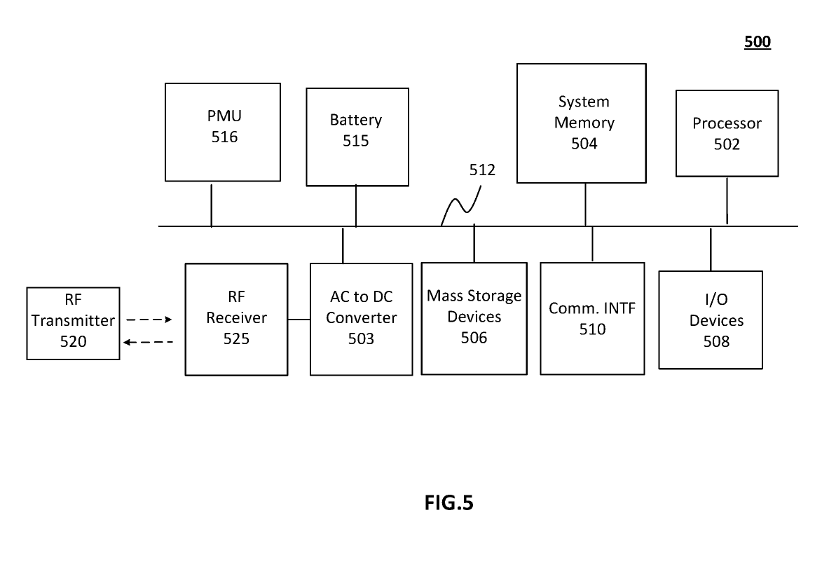

FIG. 5 illustrates an example computer system that may be suitable for use to practice selected aspects of the present disclosure. As shown, computer 500 may include one or more processors or processor cores 502, and a system memory 504. For the purpose of this application, including the claims, the term “processor” refers to a physical processor, and the terms “processor” and “processor cores” may be considered synonymous, unless the context clearly requires otherwise. Additionally, computer 500 may include an AC to DC converter 503, mass storage devices 506 (such as diskette, hard drive, compact disc read only memory (CD-ROM) and so forth), input/output (I/O) devices 508 (such as display, keyboard, cursor control, remote control, gaming controller, image capture device, and so forth), communication interfaces 510 (such as network interface cards, modems, infrared receivers, radio receivers (e.g., Bluetooth), and so forth), battery 515, power management unit (PMU) 516, radio frequency (RF) receiver 525 and RF transmitter 520. The elements may be coupled to each other via system bus 512, which may represent one or more buses. In the case of multiple buses, they may be bridged by one or more bus bridges (not shown).

In embodiments, AC to DC converter 503 may include an AC to DC converter including a rectifier stage as described in connection with FIGS. 1-4 and may be coupled to system bus 512 or may be included within one or more of the elements of computer 500. In embodiments, AC to DC converter 503 may include one or more rectifier circuits included in a rectifier stage. In embodiments, computer 500 may be a wirelessly powered device that may include a wireless energy harvesting (WEH) system including a rectifier circuit, such as rectifier circuit 201 of FIG. 2, to convert an AC induced signal to a DC voltage to provide a supply voltage for circuitry associated with one or more of the elements noted above of computer 500. In embodiments, RF transmitter 520 may transmit an RF signal to be received by RF receiver 525. In embodiments, the AC input signal to be converted by rectifier circuit 201 as discussed in connection with FIGS. 1-4 may be extracted from RF receiver 525 and provided to rectifier circuit 201 in AC to DC Converter 503. In embodiments, battery 515 may be coupled to PMU 516 to receive a voltage supply from AC to DC converter 503. In embodiments, PMU 516 may manage and provide power to various circuitry and/or elements of computer 500. In some embodiments, computer 500 may include a radio-frequency identification (RFID) tag or a near-field communication (NFC) system including selected one or more of elements 502-525. In embodiments, a rectifier circuit of AC to DC converter 503 may increase a range of operation for RFID tags and improve wireless power transfer efficiency. Note that in embodiments, increasing an efficiency of the rectifier circuit may be especially beneficial with respect to wireless power transfer efficiency. For example, alliance for wireless power (A4WP) standards may include transmit power at 6.78 MHz industrial, scientific, medical (ISM) radio bands which may allow improved x-y axes freedom for a recipient of power. Embodiments may provide improved rectifier efficiency at various ranges of distance between a receiver and transmitter.

Note that in embodiments, communication interfaces 510 may include one or more communication chips and may enable wired and/or wireless communications for the transfer of data to and from the computer 500. In embodiments, communication interfaces 510 may alternately include a transceiver including a transmitter and receiver or a communication chip including the transceiver. In some embodiments, AC to DC converter 503 may be coupled to provide a current to a power management unit that may provide power to one or more of the other blocks as shown in computer 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication interfaces 510 may implement any of a number of wireless standards or protocols, including but not limited to IEEE 702.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WiMAX), Bluetooth, derivatives thereof, as well as any other wireless protocols that are designated as 3G, 4G, 5G, and beyond. The communication interfaces 510 may include a plurality of communication chips. For instance, a first communication chip may be dedicated to shorter range wireless communications such as Wi-Fi and Bluetooth, and a second communication chip may be dedicated to longer range wireless communications such as GPS, EDGE, GPRS, CDMA, WiMAX, LTE, Ev-DO, and others.

The elements may be coupled to each other via system bus 512, which may represent one or more buses. In the case of multiple buses, they may be bridged by one or more bus bridges (not shown). Each of these elements may perform its conventional functions known in the art. The number, capability and/or capacity of these elements 502-525 may vary, depending on whether computer 500 is used as a mobile device, a stationary device or a server. In some embodiments, computer 500 may be included in an electrical car. When used as a mobile device, the capability and/or capacity of these elements 502-525 may vary, depending on whether the mobile device is a smartphone, a computing tablet, an ultrabook or a laptop. Otherwise, the constitutions of elements of computer 500 are known, and accordingly will not be further described.

Some non-limiting Examples are provided below.

Example 1 is an alternating current (AC) to direct current (DC) converter, comprising a synchronous rectifier to convert an AC input signal to a DC output signal; a feedback circuit coupled to an output terminal of the synchronous rectifier to sample the DC output signal and to generate a digital signal to represent a voltage of the DC output signal; and a controller coupled to receive the digital signal from the feedback circuit and to compare the digital signal to a threshold, and based on the comparison, to control an adjustment of the voltage of the DC output signal.

Example 2 is the AC to DC converter of Example 1, wherein the synchronous rectifier includes a metal-oxide-semiconductor-field-effect-transistor (MOSFET)-based full wave rectifier.

Example 3 is the AC to DC converter of Example 1, wherein the feedback circuit comprises an analog-to-digital converter (ADC).

Example 4 is the AC to DC converter of Example 1, further comprising a digital-to-analog converter (DAC) coupled to receive a binary signal from the controller and based on the binary signal, to generate a DC voltage to control a DC bias voltage of a transistor of the synchronous rectifier to adjust the voltage of the DC output signal.

Example 5 is the AC to DC converter of Example 4, further comprising a voltage adjustment circuit coupled to receive the DC voltage from the DAC and to apply the DC bias voltage to a gate terminal of the transistor of the synchronous rectifier.

Example 6 is the AC to DC converter of Example 5, wherein the voltage adjustment circuit to apply the DC bias voltage to the gate terminal of the transistor of the synchronous rectifier in addition to an internal AC signal of the synchronous rectifier.

Example 7 is the AC to DC converter of Example 1, wherein the synchronous rectifier comprises a first pair of N-channel metal-oxide-semiconductor (NMOS)-field-effect transistors and a second pair of P-channel metal-oxide-semiconductor (PMOS)-field-effect transistors and the adjustment of the voltage of the DC output signal includes an adjustment of gate operating voltages in the first pair of transistors and the second pair of transistors.

Example 8 is the AC to DC converter of Example 7, wherein the controller is to control an adjustment of the gate operating voltages by increasing a DC voltage level to be applied to gate terminals of the first pair of NMOS-field-effect transistors if the voltage of the DC output signal is below the threshold.

Example 9 is the AC to DC converter of Example 7, wherein the controller is to control the adjustment of the gate operating voltages by decreasing a DC voltage level to be applied to gate terminals of the second pair of PMOS-field-effect transistors if the voltage of the DC output signal is below the threshold.

Example 10 is a transistor-based rectifier stage, comprising a rectifier circuit to convert an alternating current (AC) input signal to a direct current (DC) output signal; and a digital controller coupled to receive a digital value representing a sample voltage of the DC output signal from the rectifier circuit and to compare a voltage of the DC output signal with a threshold to determine an adjustment of gate operating voltages of the rectifier circuit to adjust the voltage of the DC output signal.

Example 11 is the transistor-based rectifier stage of Example 10 wherein the digital controller is to control a bias voltage received at a terminal gate of a transistor of the rectifier circuit to adjust the voltage of the DC output signal by facilitating a current flow through the transistor.

Example 12 is the transistor-based rectifier stage of Example 11 wherein the digital controller is to receive an updated digital signal, wherein if the updated digital signal indicates a resulting decrease in the voltage of the DC output signal, the digital controller to control the bias voltage to discourage the current flow through the transistor to increase the voltage of the DC output signal.

Example 13 is the transistor-based rectifier stage of Example 10, further comprising a voltage generator circuit coupled to receive a digital signal from the digital controller and to generate a DC voltage in response to the digital signal.

Example 14 is the transistor-based rectifier stage of Example 13, further comprising a voltage adjustment circuit coupled to receive the DC voltage from the voltage generator circuit and to generate a DC voltage to apply to the gate operating voltages of the rectifier circuit to adjust the voltage of the DC output signal.

Example 15 is the transistor-based rectifier stage of Example 10, wherein the rectifier circuit comprises a first pair of N-channel metal-oxide-semiconductor (NMOS)-field-effect transistors and a second pair of P-channel metal-oxide-semiconductor (PMOS)-field-effect transistors coupled to rectify the AC input signal.

Example 16 is the transistor-based rectifier stage of Example 15, wherein the digital controller adjusts the DC output signal of the rectifier by controlling an increase in a DC voltage of gate operating voltages of the first pair of NMOS-field-effect transistors.

Example 17 is the transistor-based rectifier stage of Example 16, wherein the digital controller adjusts the DC output signal of the rectifier by controlling a decrease of a DC voltage of gate operating voltages of the second pair of PMOS-field-effect transistors.

Example 18 is a system, comprising one or more processors; a memory coupled to the one or more processors; and a rectifier stage including a rectifier circuit; a microcontroller coupled to the rectifier circuit, wherein the microcontroller includes an analog-to-digital converter (ADC) coupled to an output terminal of the rectifier circuit to sample a DC output signal generated by the rectifier circuit and to generate a signal to represent a value of the DC output signal; a controller coupled to receive the signal from the ADC and to compare the signal to a threshold, and based on the comparison, to control an adjustment of a voltage of the DC output signal; and a digital-to-analog converter (DAC) coupled to the controller to receive an instruction from the controller to generate a DC voltage to control an operating voltage of a transistor of the rectifier circuit to adjust the voltage of the DC output signal; wherein the rectifier stage is coupled to supply the adjusted DC output signal to the one or more processors or the memory.

Example 19 is the system of Example 18, wherein the rectifier circuit comprises first, second, third, and fourth metal-oxide-semiconductor-field-effect-transistor (MOSFET) devices coupled to rectify an input AC signal.

Example 20 is the system of Example 18, wherein the rectifier circuit comprises a first rectifier circuit and wherein the system further comprises a second rectifier circuit coupled to an input terminal of the first rectifier circuit and including fifth, sixth, seventh, and eighth MOSFET devices.

Example 21 is the system of Example 18, wherein the system comprises a radio-frequency identification (RFID) tag.

Example 22 is an apparatus, comprising: means for converting an alternating current (AC) input signal to a direct current (DC) output signal; means for sensing the DC output signal and for generating a digital signal to represent a voltage of the DC output signal; and means for comparing the digital signal to a threshold.

Example 23 is the apparatus of Example 22, wherein the means for comparing the digital signal to the threshold includes means for comparing the digital signal to a predetermined tolerance voltage.

Example 24 is the apparatus of Example 22, further comprising means for sending an electrical interrupt signal to interrupt the means for comparing if a movement of the apparatus is detected.

Example 25 is the apparatus of Example 24, further comprising means for detecting a movement of the apparatus.

Example 26 is an alternating current (AC) to direct current (DC) converter, comprising: a synchronous rectifier to convert an AC input signal to a DC output signal; a feedback circuit coupled to an output terminal of the synchronous rectifier to sample the DC output signal and to generate a digital signal to represent a voltage of the DC output signal; and a controller coupled to receive the digital signal from the feedback circuit, wherein if the digital signal indicates the voltage of the DC output signal is below a voltage threshold, the controller to: control a bias voltage received at a terminal gate of a transistor of the synchronous rectifier to increase the voltage of the DC output signal by facilitating a current flow through the transistor; and receive an updated digital signal, wherein if the updated digital signal indicates a resulting decrease in the voltage of the DC output signal, control the bias voltage to discourage the current flow through the transistor to increase the voltage of the DC output signal.

Example 27 is the AC to DC converter of Example 26, wherein the synchronous rectifier includes a metal-oxide-semiconductor-field-effect-transistor (MOSFET)-based full wave rectifier.

Example 28 is the AC to DC converter of Example 26, further comprising a digital-to-analog converter (DAC) coupled to receive a binary signal from the controller and, based on the binary signal, to generate a DC voltage to increment or decrement the bias voltage to increase the voltage of the DC output signal.

Example 29 is the AC to DC converter of Example 28, wherein the transistor is an N-channel metal-oxide-semiconductor (NMOS)-field-effect transistor and wherein the DAC is to generate the DC voltage to increment the bias voltage received at the NMOS-field-effect transistor to increase the current flow through the transistor.

Example 30 is the AC to DC converter of Example 28, wherein the transistor is a P-channel metal-oxide-semiconductor (PMOS)-field-effect transistor and wherein the DAC is to generate the DC voltage to decrement the bias voltage received at the (PMOS)-field-effect transistor to increase the current flow through the transistor.

Example 31 is the AC to DC converter of Example 30, wherein, if the updated digital signal indicates a resulting decrease in the voltage of the DC output signal, the controller is to increment the bias voltage received at the PMOS-field-effect transistor to decrease a leakage current of the PMOS-field-effect transistor.

Example 32 is the AC to DC converter of Example 29, wherein, if the updated digital signal indicates a resulting decrease in the voltage of the DC output signal, the controller is to decrement the bias voltage received at the NMOS-field-effect transistor to decrease a leakage current of the NMOS-field-effect transistor.

Example 33 is the AC to DC converter of Example 28, further comprising a voltage adjustment circuit coupled to receive the DC voltage from the DAC and to apply the bias voltage to a gate terminal of the transistor in addition to an internal AC signal of the synchronous rectifier.

Example 34 is the AC to DC converter of any of one of Examples 26-33, wherein the feedback circuit comprises an analog-to-digital converter (ADC).

Example 35 is a transistor-based rectifier stage, comprising: a rectifier circuit to convert an alternating current (AC) input signal to a direct current (DC) output signal; and a digital controller coupled to receive a digital value representing a sample voltage of the DC output signal from the rectifier circuit and to compare a voltage of the DC output signal with a threshold, wherein, if the voltage of the DC output signal is below the threshold, the digital controller is to: control an increase in the voltage of the DC output signal by facilitating a current flow through a transistor of the rectifier circuit; and receive an updated digital value to monitor the voltage of the DC output signal, wherein if the updated digital value indicates a resulting decrease in the voltage of the DC output signal, controller is to discourage the current flow through the transistor to adjust the voltage of the DC output signal.

Example 36 is the transistor-based rectifier stage of Example 35, wherein the transistor-based rectifier stage includes a metal-oxide-semiconductor-field-effect-transistor (MOSFET)-based full wave rectifier stage.

Example 37 is the transistor-based rectifier stage of Example 35, further comprising a feedback circuit coupled to an output terminal of the rectifier circuit to sense the DC output signal and to generate the digital value received by the digital controller.

Example 38 is the transistor-based rectifier stage of Example 35, further comprising a voltage generator circuit coupled to receive a digital signal from the digital controller and to generate a DC voltage in response to the digital signal.

Example 39 is the transistor-based rectifier stage of Example 38, further comprising a voltage adjustment circuit coupled to receive the DC voltage from the voltage generator circuit and to provide the DC voltage for addition to an internal AC signal of the rectifier circuit to adjust the voltage of the DC output signal.

Example 40 is the transistor-based rectifier stage of Example 35, wherein the rectifier circuit comprises a first pair of N-channel metal-oxide-semiconductor (NMOS)-field-effect transistors and a second pair of P-channel metal-oxide-semiconductor (PMOS)-field-effect transistors coupled to rectify the AC input signal.

Example 41 is the transistor-based rectifier stage of Example 40, wherein, if the updated digital value indicates a resulting decrease in the voltage of the DC output signal, the controller is to control an increment of a bias voltage received at a gate terminal of the PMOS-field-effect transistor to decrease a leakage current of the PMOS-field-effect transistor.

Example 42 is the transistor-based rectifier stage of Example 41, wherein, if the updated digital signal indicates a resulting decrease in the voltage of the DC output signal, the controller is to control a decrement of a bias voltage received at a gate terminal of the NMOS-field-effect transistor to decrease a leakage current of the NMOS-field-effect transistor.

Example 43 is a system, comprising: one or more processors; a memory coupled to the one or more processors; and a rectifier stage including: a rectifier circuit; a microcontroller coupled to the rectifier circuit, wherein the microcontroller includes: an analog-to-digital converter (ADC) coupled to an output terminal of the rectifier circuit to sample a DC output signal generated by the rectifier circuit and to generate a signal to represent a value of the DC output signal; a controller coupled to receive the signal from ADC and to compare the signal to a threshold, and based on the comparison, to control an adjustment of a voltage of the DC output signal; and a digital-to-analog converter (DAC) coupled to the controller to receive an instruction from the controller to perform the adjustment by generating a DC voltage to facilitate a current flow through a transistor of the rectifier circuit by adjusting a DC bias voltage received at a terminal gate of the transistor; and based on a first updated signal to the controller indicating a resulting decrease of the voltage of the DC output signal, discourage the current flow through the transistor to increase the voltage of the DC output signal; wherein the rectifier stage is coupled to supply the adjusted DC output signal to the one or more processors or the memory.

Example 44 is the system of Example 43, wherein the system further includes a power management unit (PMU) and a battery, wherein the PMU is to be coupled between the rectifier stage and the battery to provide power to the one or more processors or the memory.

Example 45 is the system of Example 44, wherein the system comprises a wireless energy harvesting (WEH) system and the battery includes a rechargeable battery.

Example 46 is the system of any one of Examples 43-45, further comprising an antenna to receive an induced AC incident signal to be provided to the rectifier stage.

Example 47 is the system of Example 43, wherein the system comprises a radio-frequency identification (RFID) tag.

Example 48 is an apparatus, comprising means for converting an alternating current (AC) input signal to a direct current (DC) output signal; means for sensing the DC output signal and for generating a digital signal to represent a voltage of the DC output signal; means for comparing the digital signal to a threshold; and means for, based on the comparison, facilitating a current flow to control an increase in the voltage of the DC output signal, wherein if a first updated digital signal indicates a resulting decrease in the voltage of the DC output signal, discouraging the current flow to increase the voltage of the DC output signal.

Example 49 is the apparatus of Example 48, further comprising means for receiving the AC input signal.

Example 50 is the apparatus of Example 48, further comprising means for sending an electrical interrupt signal to interrupt the means for comparing if a movement of the apparatus is detected.

Although certain embodiments have been illustrated and described herein for purposes of description, this application is intended to cover any adaptations or variations of the embodiments discussed herein. Therefore, it is manifestly intended that embodiments described herein be limited only by the claims. Where the disclosure recites “a” or “a first” element or the equivalent thereof, such disclosure includes one or more such elements, neither requiring nor excluding two or more such elements. Further, ordinal indicators (e.g., first, second, or third) for identified elements are used to distinguish between the elements, and do not indicate or imply a required or limited number of such elements, nor do they indicate a particular position or order of such elements unless otherwise specifically stated.

1. An alternating current (AC) to direct current (DC) converter, comprising:
a synchronous rectifier to convert an AC input signal to a DC output signal;
a feedback circuit coupled to an output terminal of the synchronous rectifier to sample the DC output signal and to generate a digital signal to represent a voltage of the DC output signal;
a controller coupled to receive the digital signal from the feedback circuit and to compare the digital signal to a threshold, and based on the comparison, to produce a binary signal; and
a digital-to-analog converter (DAC) coupled to receive the binary signal from the controller and, based on the binary signal, to generate a DC voltage to be applied to a gate terminal of a transistor of the synchronous rectifier to adjust a DC bias voltage level of the transistor to control the voltage of the DC output signal.

2. The AC to DC converter of claim 1, wherein the synchronous rectifier includes a metal-oxide-semiconductor-field-effect-transistor (MOSFET)-based full wave rectifier.

3. The AC to DC converter of claim 1, wherein the feedback circuit comprises an analog-to-digital converter (ADC).

4. (canceled)

5. The AC to DC converter of claim 1, further comprising a voltage adjustment circuit coupled to receive the DC voltage from the DAC and to apply the DC voltage to the gate terminal of the transistor of the synchronous rectifier.

6. The AC to DC converter of claim 5, wherein the voltage adjustment circuit is to apply the DC voltage to the gate terminal of the transistor of the synchronous rectifier in addition to an internal AC signal of the synchronous rectifier.

7. The AC to DC converter of claim 1, wherein the synchronous rectifier comprises a first pair of N-channel metal-oxide-semiconductor (NMOS)-field-effect transistors and a second pair of P-channel metal-oxide-semiconductor (PMOS)-field-effect transistors and the adjustment of the voltage of the DC output signal includes an adjustment of gate operating voltages in the first pair of transistors and the second pair of transistors.

8. The AC to DC converter of claim 7, wherein the controller is to control an adjustment of the gate operating voltages by increasing a DC voltage level to be applied to gate terminals of the first pair of NMOS-field-effect transistors if the voltage of the DC output signal is below the threshold.

9. The AC to DC converter of claim 7, wherein the controller is to control the adjustment of the gate operating voltages by decreasing a DC voltage level to be applied to gate terminals of the second pair of PMOS-field-effect transistors if the voltage of the DC output signal is below the threshold.

10. A transistor-based rectifier stage, comprising:
a rectifier circuit to convert an alternating current (AC) input signal to a direct current (DC) output signal; and
a digital controller coupled to receive a digital value representing a sample voltage of the DC output signal from the rectifier circuit and to compare a voltage of the DC output signal with a threshold to determine an adjustment of gate operating voltages by determining a DC voltage to apply to a gate terminal of a transistor of the rectifier circuit to adjust a DC bias voltage level to control the voltage of the DC output signal.

11. The transistor-based rectifier stage of claim 10 wherein the digital controller is to control the DC bias voltage level of the rectifier circuit to adjust the voltage of the DC output signal by facilitating a current flow through the transistor.

12. The transistor-based rectifier stage of claim 11 wherein the digital controller is to receive an updated digital signal, wherein if the updated digital signal indicates a resulting decrease in the voltage of the DC output signal, the digital controller is to control the DC bias voltage level to discourage the current flow through the transistor to increase the voltage of the DC output signal.

13. The transistor-based rectifier stage of claim 10, further comprising a voltage generator circuit coupled to receive a digital signal from the digital controller and to generate a DC voltage in response to the digital signal.

14. The transistor-based rectifier stage of claim 13, further comprising a voltage adjustment circuit coupled to receive the DC voltage from the voltage generator circuit and to apply the DC voltage to the gate terminal to adjust the voltage of the DC output signal.

15. The transistor-based rectifier stage of claim 10, wherein the rectifier circuit comprises a first pair of N-channel metal-oxide-semiconductor (NMOS)-field-effect transistors and a second pair of P-channel metal-oxide-semiconductor (PMOS)-field-effect transistors coupled to rectify the AC input signal.

16. The transistor-based rectifier stage of claim 15, wherein the digital controller adjusts the DC output signal of the rectifier by controlling an increase in a DC voltage of gate operating voltages of the first pair of NMOS-field-effect transistors.

17. The transistor-based rectifier stage of claim 16, wherein the digital controller adjusts the DC output signal of the rectifier by controlling a decrease of a DC voltage of gate operating voltages of the second pair of PMOS-field-effect transistors.

18. A system, comprising:
one or more processors;
a memory coupled to the one or more processors; and
a rectifier stage including:
a rectifier circuit;
a microcontroller coupled to the rectifier circuit, wherein the microcontroller includes:
an analog-to-digital converter (ADC) coupled to an output terminal of the rectifier circuit to sample a DC output signal generated by the rectifier circuit and to generate a signal to represent a value of the DC output signal;
a controller coupled to receive the signal from the ADC and to compare the signal to a threshold, and based on the comparison, to control an adjustment of a voltage of the DC output signal; and
a digital-to-analog converter (DAC) coupled to the controller to receive an instruction from the controller to generate a DC voltage to be applied to a gate terminal of a transistor in the rectifier circuit to adjust a DC bias voltage level of the transistor and control the voltage of the DC output signal;
wherein the rectifier stage is coupled to supply the adjusted DC output signal to the one or more processors or the memory.

19. The system of claim 18, wherein the rectifier circuit comprises first, second, third, and fourth metal-oxide-semiconductor-field-effect-transistor (MOSFET) devices coupled to rectify an input AC signal.

20. The system of claim 18, wherein the rectifier circuit comprises a first rectifier circuit and wherein the system further comprises a second rectifier circuit coupled to an input terminal of the first rectifier circuit and including fifth, sixth, seventh, and eighth MOSFET devices.

21. The system of claim 18, wherein the system comprises a radio-frequency identification (RFID) tag.

22. An apparatus, comprising:
means for converting an alternating current (AC) input signal to a direct current (DC) output signal;
means for sensing the DC output signal and for generating a digital signal to represent a voltage of the DC output signal; and
means for comparing the digital signal to a threshold.

23. The apparatus of claim 22, wherein the means for comparing the digital signal to the threshold includes means for comparing the digital signal to a predetermined tolerance voltage.

24. The apparatus of claim 22, further comprising means for sending an electrical interrupt signal to interrupt the means for comparing if a movement of the apparatus is detected.

25. The apparatus of claim 24, further comprising means for detecting a movement of the apparatus.
